(19) United States
(12) Patent Application Publication
(10) Pub. No.: US 2018/0144366 A1
(43) Pub. Date: May 24, 2018

(54) Method of Monetizing Internet Content

(71) Applicant: Eric Kramer, Pinetop, AZ (US)

(72) Inventor: Eric Kramer, Pinetop, AZ (US)

(21) Appl. No.: 15/355,106

(22) Filed: Nov. 18, 2016

(51) Int. Cl. G06Q 30/02

(52) U.S. Cl. CPC G06Q 30/0256; G06Q 30/0273

(57) ABSTRACT

The current invention provides a way for Internet users to determine what content of interest to them is available behind multiple paywalls without specifically subscribing to the paywall websites. It allows these users to maintain a single account with a search engine content provider to make payments for viewing selected items behind the paywalls. It allows search engines to establish relationships with paywall websites to search their content, allows the search engines to establish relationships with Internet users to provide them with paywall restricted content, allows the search engines to present search results from behind paywalls, allows the search engines to present the restricted content to their users and to split revenue with the content providers. The content providers are able to monetize their content without establishing relationships with individual Internet users.

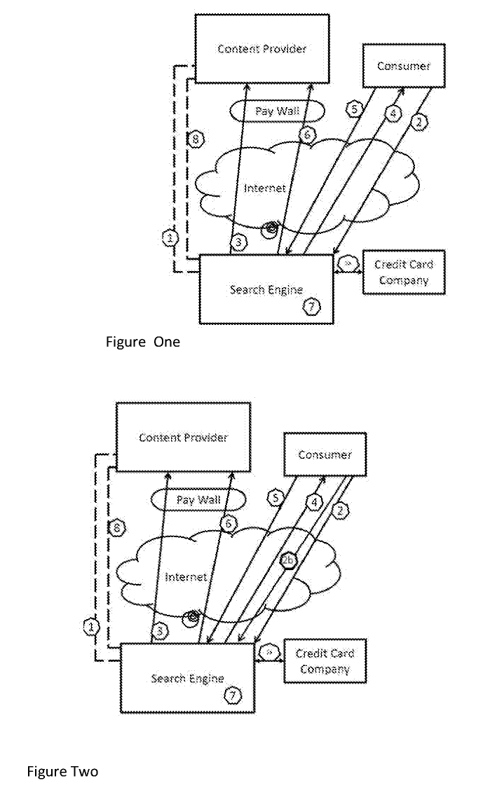

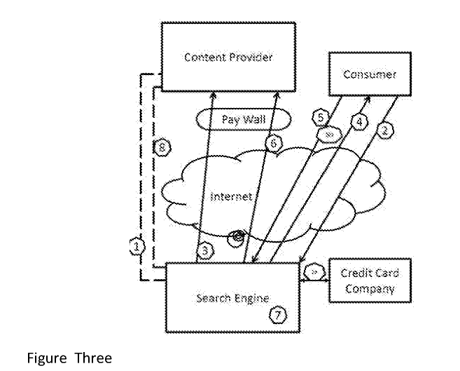

### RELATED U.S. APPLICATION DATA

Provisional application 62/203,774, Aug. 11, 2015

### FEDERALLY SPONSORED RESEARCH

Not Applicable

### MATERIAL SUBMITTED SEPARATELY

Not Applicable

### FIELD OF INVENTION

The present invention relates to the field of Internet Content and more specifically, to monetizing content.

### BACKGROUND OF INVENTION

It would be desirable for Internet content providers to have a way to get paid for their efforts. Internet advertising only provides a partial solution, with its financial rewards falling mostly to mass market websites after they have achieved a substantial following. Paywalls as currently implemented have had limited success. Internet users generally do not know what they would get if they subscribed. There is a high threshold for potential subscribers to sign up with a paywall website as they do not know what content they would receive or how often then would visit the site. Also, paywalls force users to select particular websites without the ability, absent multiple subscriptions, to receive paywall content from a broad search of the Internet. It would be desirable for Internet users to be able to learn what paywall content is available across a large part of the Internet, maintain a single paywall subscription with a single provider, and rely on their provider to make payments (often micro payments) to the content sites they visit. It would be desirable for the content providers to receive compensation from a large number of Internet users without establishing payment relationships with each individual. It would be desirable for search providers to be able to show users excerpts of content from behind paywalls and collect a fee from their users who want to see a particular item.

### BRIEF SUMMARY OF INVENTION

The present invention, which is implemented on a machine using a computer program, fills the need for a method of monetizing Internet content.

It allows content providers to establish a special advantageous relationship with Internet search providers. The search providers are able to access material behind a content provider's paywall so that they can provide brief excerpts of the content to Internet users in the form of search results. Internet users who desire to see paywall-protected content from multiple search providers would establish an account with the search provider, creating a modest balance in the account.

If an Internet user with an account desired to see a paywall protected item from behind a paywall, the user would click on the item. The URL provided by the search provider would initially take the transaction to the search provider website. The website would debit the appropriate amount from the account, provide a security token and re-direct the user to the content provider website. The content provider website would validate the token with the search engine website and present the content to the user.

The invention has these advantages to the search engine provider over existing paywall methods. The search engine provider is involved in the paywall transaction and can receive an agreed upon share of the fee for access to the paywall content. The search provider can make agreements with multiple content providers to present their content.

The invention has these advantages to the content provider. Excerpts of the content provider's information would be available widely on the Internet for discovery through the search engine. The content provider would not need to create an individual method for collecting fees, but could get periodic payments from the search provider. The content provider would not need to individually establish relationships with Internet users. This would reduce the “friction” faced by the content provider. It is difficult to establish relationships with Internet users over a wide geographic area. The users are reluctant to establish a relationship where they have to pay a large annual or monthly fee for content they may not access. If the user has an account with the search engine company, they can click on a search result and view it with very little friction. They would not have to establish a relationship with the individual paywall content provider, would not have to get out their credit card and expose themselves to transaction risk. Most importantly, the fee for viewing the content could be extremely low in comparison to traditional paywall websites. For example, a small content provider collecting 1,000 dimes a day through a search engine would be far better off than a go-it-alone content provider who may only get a few $20 subscriptions a week. The invention brings the reach of the Internet to paywall content providers.

The invention has these advantages to Internet users. They can receive rich proprietary content without subscribing to multiple paywall websites. They can receive proprietary content in their search results. They can view proprietary items by clicking on the search results. This reduction in friction allows the user to see more content of greater interest to them at a much lower cost.

In certain embodiments, the search provider would determine if the user had a subscription to the paywall website and therefore not charge the user for accessing content to the particular website. The user could register subscriptions to paywall websites with the search engine to help avoid double charging. Alternatively, the paywall website could respond to the search provider, alerting them that the user involved in a transaction had the appropriate cookie on their machine and was not subject to additional charges for viewing content.

In certain embodiments, the intention may track an Internet users spending with a particular website and provide a reduced fee or even free content if the user spends a certain amount with a particular website. This threshold may or may not be tied to the subscription price of the paywall website.

### BRIEF DESCRIPTION OF THE DRAWINGS

Figure One

1. Search Engine company reaches agreement with content provider to scan content behind paywall and make it available on per-use basis to consumers.

2. Consumer establishes account with Search Engine company and sets up a small balance in the account that can be refreshed (2a) as needed via the credit card company.

3. Search Engine scans the content of the content provider.

4. Search Engine begins returning the content in search results to consumers, with an indication that an account must be established to view the content.

5. Consumer clicks on a search result that is behind the pay wall and the Search Engine issues a token that allows the user to retrieve the content and makes a charge to the consumer's account.

6. The consumer is re-directed through the paywall and the content is returned

7. The Search engine makes a record of the transaction that indicates how the fee will be split with the content provider.

8. The Search Engine makes a periodic payment to the content provider.

Figure Two

1. Search Engine company reaches agreement with content provider to scan content behind paywall and make it available on per-use basis to consumers.

2. Consumer establishes account with Search Engine company and sets up a small balance in the account that can be refreshed (2a) as needed via the credit card company. (2b) Consumer registers content subscriptions with Search Engine.

3. Search Engine scans the content of the content provider.

4. Search Engine begins returning the content in search results to consumers, with an indication that an account must be established to view the content, or, if the Search Engine has a registered subscription between the Search Engine and content provider, indicates that the consumer has a subscription.

5. Consumer clicks on a search result that is behind the pay wall and the Search Engine issues a token that allows the user to retrieve the content and makes a charge to the consumer's account, or if the consumer has a registered subscription, redirects the consumer without charge. (If the consumer has a subscription, the redirect is done without charge or token and the user views the content based on their subscription rights.)

6. The consumer is re-directed through the paywall and the content is returned

7. The Search engine makes a record of the transaction that indicates how the fee will be split with the content provider.

8. The Search Engine makes a periodic payment to the content provider.

Figure Three

1. Search Engine company reaches agreement with content provider to scan content behind paywall and make it available on per-use basis to consumers.

2. Consumer establishes account with Search Engine company and sets up a small balance in the account that can be refreshed (2a) as needed via the credit card company.

3. Search Engine scans the content of the content provider.

4. Search Engine begins returning the content in search results to consumers, with an indication that an account must be established to view the content.

5. Consumer clicks on a search result that is behind the pay wall and the Search Engine issues a token that allows the user to retrieve the content and makes a charge to the consumer's account. (5B) In an alternate method, the search engine begins to provide discounts or even free access as the consumer's monthly usage with a content provider approaches a threshold that may or may not be tied to the provider's periodic subscription fee.

6. The consumer is re-directed through the paywall and the content is returned

7. The Search engine makes a record of the transaction that indicates how the fee will be split with the content provider.

8. The Search Engine makes a periodic payment to the content provider.

### DETAILED DESCRIPTION OF THE INVENTION

Monetizing content offered on the Internet provides many challenges to content providers.

Paid content is a challenge for the customer. What paywall sites really have content that they would like to read? How many subscriptions to paywall sites do they need to meet their needs? If they have a number of subscriptions, they are not assured of getting the best content, or most applicable to their needs, as the best content could be hidden behind another paywall.

For a new content provider, the subscription model is difficult, especially if the content provider does not have a substantial presence and reputation outside the Internet. Customers are very leery of paying for content from a little known provider, if they even know the content provider exists, which is doubtful. With the prospect of substantial revenue from subscriptions far down the road, there is a substantial bar to entry of new content providers. Providers find that potential customers show considerable resistance to paying for the unknown. Because this subscription model limits the potential reach of the full Internet, subscription costs are relatively high and bring in less money than a system that would provide the full reach of the Internet with much lower prices.

For search providers, the area of paywall content provides challenges as well. The search providers often cannot provide their users with results from beyond the paywall. If they are able to index paywall content, often their users are not allowed to see the content without buying a subscription.

Advertising is also limited in its ability to support content providers. Low volumes of page views produce little advertising revenue for new content providers. Advertising takes away valuable page space from content, and can be so intrusive that it makes a content provider website hard for the viewer to use. The need to get large numbers of page views for advertising revenue skews the quality of content downward. A story on the indiscretions of an Internet celebrity may get millions of page views while an item on an important scientific breakthrough might get a tiny fraction of those views. Content providers that rely on advertising revenues are tempted, or forced, to pursue the sensational while ignoring the substantive.

The Contribution model is also extremely limited. It is hard to get people to pay for something that is being offered for free. A very small portion of viewers would be willing to make contributions. Also, it is even more difficult to get their continued participation, making revenue for contribution-based sites extremely erratic.

There is a cultural expectation that Internet content should be free. People who would pay $6 for a sandwich and a soft drink without a thought would be reluctant to pay $25 for a yearly subscription to an important content site. To monetize Internet content, a solution is required that allows users to purchase content item-by-item so the content can be purchased without giving it a thought.

The need is for an invention that would provide content providers and search providers with a steady stream of revenue. There should be no requirement that the content providers pre-sell their content to the users. The content should be exposed to the full reach of the Internet without making it free.

Providers should be able to make their content available to any Internet user who places appropriate terms into a search engine, without giving away the content. The providers should be able to monetize the content without pre-establishing a relationship with the potential user.

Customers should be able to see excerpts of all available content without paying for the full content in advance through a subscription. They should be able to view the full content for a low price consistent with the content being made available to the full Internet, rather than an artificially high price necessitated by low volumes in existing paywall implementations.

Search providers should be able to offer the full content of paywall providers. The search providers should be able to earn revenue by facilitating the viewing of the content by users.

The invention provides content providers and search providers with the ability to cooperate to satisfy customer needs. It provides an economic engine to drive creation of high quality and diverse Internet content. It does this by bringing into play the full reach of the Internet. It would provide an increase in the depth of Internet content. Through facilitating search of paid content, the user could be exposed to more content and content more targeted to their queries than can be provided on a home page. The content would not be limited by time, such as when only the most recent articles are available on a home page. Also, the content would not be limited by mass market appeal necessitated by a desire for increased advertising revenue.

The invention provides several advantages to an Internet user. The cost of obtaining premium content would be greatly reduced as the individual could purchase an individual item rather than purchasing a subscription. As the volume of Internet content purchase would reach a much higher scale, the cost of purchasing an individual item could be much lower. It would also provide convenience to the individual user. Rather than maintaining subscriptions to multiple paywall websites, they could maintain a relationship with a single search provider with relationships with many content providers. The user would benefit as the invention would also encourage the creation of higher quality and more diverse content supported by a new revenue stream. The user would not be paying for content that he or she did not access. There would be an improvement in security for the Internet user, who would not have to provide a credit card to multiple websites, but instead could limit financial dealings with a single search provider.

The invention would provide a new source of revenue for search providers in splitting the content access fees with the content providers. It would also increase the reach of content providers. They could scan websites behind paywalls and also have this unique feature to offer to expand their user base. The aspect of maintaining a “wallet” for the user also has many opportunities for expanded features. In particular, the wallet could be used for purchases other than Internet content.

The invention has many advantages for content providers. They would benefit from a new revenue source. By establishing a relationship with a search engine that facilitated purchase of content, they could develop a revenue stream much faster than developing their own subscription base. This faster roll out of paid content would give them more page views, which could provide revenue from advertising views and clicks. A beneficial relationship with an established search engine would greatly expand the content providers reach, and allow the establishment of a paid content site with far less programming and cost.

### How It Works

1. A Search Engine company would reach agreement with a content provider to scan content that was not available for free on the Internet. The search provider and the content provider would also reach agreement to share revenue from users who purchase content on a per-item basis.
2. The consumer would establish an account with a Search Engine company and set up a small balance in the account that can be refreshed as needed via a credit card company or other financial services provider.
3. The Search Engine would scan the content of the content provider.
4. The Search Engine would return the content in search results to consumers, with an indication that an account must be established to view the content. The search engine would allow the users to create accounts.
5. The consumer would click on a search result for non-free content and the Search Engine would issue a token or provide other secure electronic means that allows the user to retrieve the content from the content provider website. The search provider would make a charge to the consumer's account.
6. The consumer would be re-directed through the paywall and the content would returned
7. The Search engine would make a record of the transaction that indicates how the fee will be split with the content provider.
8. The Search Engine makes a periodic payment to the content provider.
In an alternative implementation, the search provider could host the content provider content and control access directly.
In an alternative implementation, the search provider could track whether the user has an existing subscription to particular content and direct them to the site using their subscription credentials rather than charging them for one-time access.

In an alterntive implementation, the Search Engine could advise the user when a usage threshold is reached that would make a subscription advantageous, and could sell the subscription to the content provider website.

1. A method of monetizing Internet content by establishing a relationship between a Search Engine and a content provider.

2. A method of creating a relationship between a Search Engine and a consumer to pay for items.

3. A method of using a consumer account to pay for items.

4. A method of authorizing an Internet user to see selected content from behind a paywall.

5. A method of collecting fees for exposing Internet content from behind a paywall.
